(19) United States
(12) Patent Application Publication
(10) Pub. No.: US 2025/0222882 A1
(43) Pub. Date: Jul. 10, 2025

(54) PILLAR GARNISH ASSEMBLY FOR A VEHICLE

(71) Applicant: Honda Motor Co., Ltd., Tokyo (JP)

(72) Inventor: Timothy J. Rupp, Dublin, OH (US)

(21) Appl. No.: 18/407,153

(22) Filed: Jan. 8, 2024

(51) Int. Cl. B60R 13/04; B60R 13/06

(52) U.S. Cl. CPC B60R 13/04; B60R 13/06

(57) ABSTRACT

A pillar garnish assembly for a vehicle includes a pillar garnish adapted to be provided on a front surface of a pillar of the vehicle and a seal adapted to engage with the pillar garnish. The seal includes a first seal structure adapted to be arranged between the pillar garnish and the pillar and configured to be engaged with the pillar garnish. The seal also includes a second seal structure having a hook portion engaged with the first seal structure and defining a gap to receive a portion of the pillar garnish. The second seal structure further includes a seal portion extending at an angle to the hook portion and away from the hook portion. The seal portion is adapted to seal a space defined between the pillar and a fender of the vehicle.

### BACKGROUND

The disclosed subject matter relates generally to a vehicle. More particularly, the disclosed subject matter relates to a pillar garnish assembly for an A-pillar of a vehicle.

Vehicles generally include pillar garnishes applied to A-pillars of the vehicles. Currently, there exists a gap between the pillar garnish and a fender at bottom of the front windshield of the vehicle. To achieve a good sealing and cover the gap, an additional part is arranged between the pillar garnish and the fender. However, the additional part provided poor appearance and adds to the cost.

### SUMMARY

In accordance with one embodiment of the present disclosure, a pillar garnish assembly for a vehicle is disclosed. The pillar garnish assembly comprises a pillar garnish adapted to be provided on a front surface of a pillar of the vehicle and a seal adapted to engage with the pillar garnish. The seal includes a first seal structure adapted to be arranged between the pillar garnish and the pillar and configured to be engaged with the pillar garnish. The seal also includes a second seal structure having a hook portion engaged with the first seal structure and defining a gap to receive a portion of the pillar garnish. The second seal structure further includes a seal portion extending at an angle to the hook portion and away from the hook portion. The seal portion is adapted to seal a space defined between the pillar and a fender of the vehicle.

In accordance with another embodiment of the present disclosure, a vehicle is disclosed. The vehicle comprises a pillar, a fender extending forwardly and downwardly of the pillar and defining a space therebetween, and a pillar garnish provided on a front surface of the pillar. The vehicle also includes a seal engaged with the pillar garnish and including a first seal structure arranged between the pillar garnish and the pillar and engaged with the pillar garnish, and a second seal structure having a hook portion engaged with the first seal structure and defining a gap. A portion of the pillar garnish extends inside the gap. Moreover, the second seal structure includes a seal portion extending at an angle to the hook portion and away from the hook portion. The seal portion is arranged covering the space defined between the pillar and the fender.

In accordance with yet a further embodiment of the present disclosure a method for forming a pillar garnish assembly for a vehicle is disclosed. The method comprises providing a pillar garnish, and a seal. The seal includes a first seal structure adapted to be arranged between the pillar garnish and a pillar of the vehicle. The first seal structure is configured to be engaged with the pillar garnish. The seal also includes a second seal structure having a hook portion engaged with the first seal structure and defining a gap to receive a portion of the pillar garnish. The second seal structure also includes a seal portion extending at an angle to the hook portion and away from the hook portion. The seal portion is adapted to seal a space defined between the pillar and the fender. The method further includes increasing the gap of the hook portion, and inserting a lower portion of the pillar garnish inside the gap. Moreover, the method includes displacing the pillar garnish and the seal portion towards the first seal structure to reduce the gap such that the lower portion of the pillar garnish is arranged inside the gap and an upper portion of the pillar garnish is sandwiched between the first seal structure and the second seal structure.

### BRIEF DESCRIPTION OF THE DRAWINGS

Certain embodiments of the present disclosure will be better understood from the following description taken in conjunction with the accompanying drawings in which:

FIG. 1 is a perspective view of a vehicle, in accordance with one embodiment of the present disclosure;

FIG. 2 is a section view of the vehicle along section line A-A depicting a pillar garnish assembly of the vehicle, in accordance with one embodiment of the present disclosure; and

FIGS. 3-5, depict various steps of a method of forming the pillar garnish assembly, in accordance with one embodiment of the present disclosure.

### DETAILED DESCRIPTION OF EXEMPLARY EMBODIMENTS

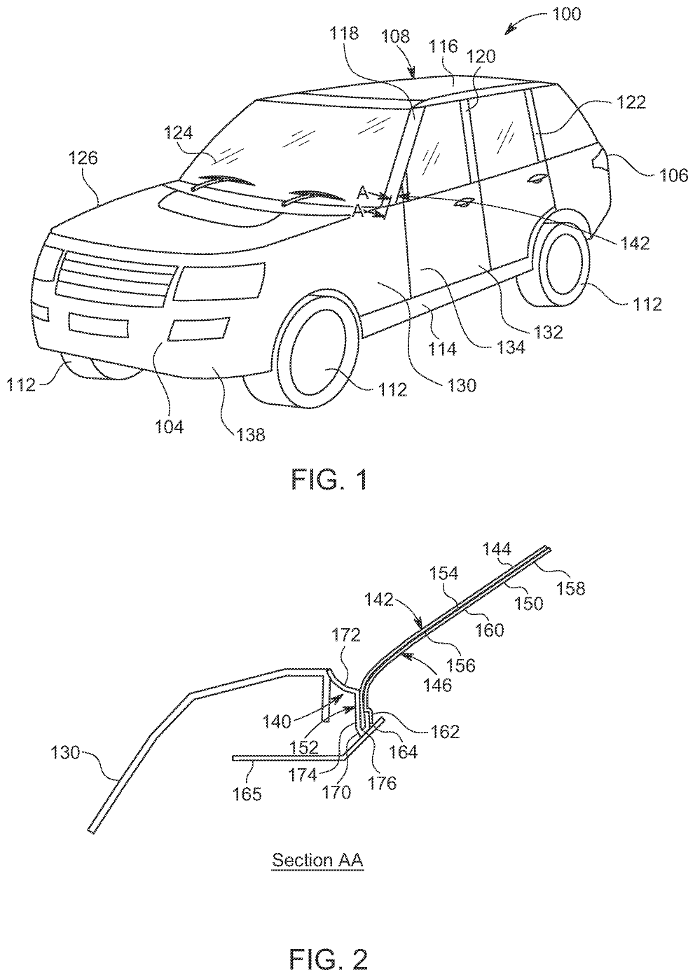

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Embodiments are hereinafter described in detail in connection with the views and examples of FIGS. 1-5, wherein like numbers indicate the same or corresponding elements throughout the views.

FIG. 1 illustrates a perspective view of a vehicle 100, in accordance with one embodiment of the present disclosure. As shown, the vehicle 100 includes a front end 104, a rear end 106, and a vehicle body 108 extending from the front end 104 to the rear end 106 and defining a passenger compartment for facilitating a seating of one or more passenger inside the vehicle 100. Further, the vehicle 100 includes a plurality of wheels 112 supporting the vehicle body 108 on a surface and enables a movement of the vehicle 100 over the surface. As shown, the vehicle body 108 includes a floor 114 on which one or more seats are mounted and a roof 116 arranged opposite to the floor 114 and supported on a plurality of pillars, for example, A-pillars 118, B-pillars 120, and C-pillars 122 of the vehicle body 108. Further, the vehicle 100 includes a front windshield 124 arranged between the A-pillars 118 and the roof 116 of the vehicle 100. Moreover, the vehicle body 108 includes a bonnet 126 extending forwardly of the front windshield 124 to the front end 104 to cover an engine compartment from top, and a pair of fenders 130 extending along a portion of longitudinal sides 132 of the vehicle 100. Each of the fender 130 extends between associated front gate 134 of the passenger compartment and a front bumper 138 of the vehicle body 108 and extends downwardly and forwardly of associated A-pillar 118. As shown, the fender 130 is arranged such that a space 140 (shown in FIG. 2) is defined between a portion of the fender arranged adjacent to the associated A-pillar 118. To cover the A-pillars 118 and the spaces 140 defined between the A-pillars 118 and the fenders 130, the vehicle 100 includes a pair of pillar garnish assemblies 142 attached to the A-pillars 118.

As shown, the pillar garnish assembly 142 includes a pillar garnish 144 extending along at least a portion of the A-pillar 118 and arranged covering an outer/front/upper surface of the A-pillar 118. Further, the pillar garnish assembly 142 includes a seal 146 engaged/attached/connected with the pillar garnish 144 and arranged covering the space 140.

As shown in FIGS. 2 to 5, the seal 146 includes a first seal structure 150 arranged between the pillar garnish 144 and the front/outer/upper surface of the A-pillar 118 and engaged with the pillar garnish 144, and a second seal structure 152 coupled to the first seal structure 150 and arranged covering the space 140. The first seal structure 150 extends along the length of the pillar garnish 144 and is arranged underneath/beneath the pillar garnish 144 with a front surface 154 of the first seal structure 150 disposed abutting a rear surface 156 of the pillar garnish 144. Moreover, a rear surface 158 of the first seal structure 150 is arranged abutting the outer/front surface of the A-pillar 118.

As shown, the first seal structure 150 includes a first elongated portion 160 extending along the pillar garnish 144, contacting the rear surface 156 of the pillar garnish 144, and a second elongated portion 162 extending from the first elongated portion 160 to a lower end 164 (i.e., second end) of the first seal structure 150. The second elongated portion 162 is disposed downwardly of the fender 130 and may contact a body panel 165. Moreover, the second elongated portion 162 is disposed at an offset from the rear surface 156 of the pillar garnish 144 defining a cavity 166 therebetween. As shown, the second elongated portion 162 is arranged rearwardly of the first elongated portion 160 in the longitudinal direction, and a step 168 is defined at an interface/junction of the first elongated portion 160 and the second elongated portion 162. Further, as shown in FIG., the first elongated portion 160 constitutes a majority of the first seal structure 150. In the assembly of the seal 146 with the pillar garnish 144, the second elongated portion 162 is arranged distally from the rear surface 156 of the pillar garnish 144 relative to the first elongated portion 160, therefore, the step 168 is arranged between the pillar garnish 144 and the second elongated portion 162. In some embodiments, the second elongated portion 162 may be omitted.

Furthermore, the second seal structure 152 of the seal 146 is engaged with the first seal structure 150 and includes a hook portion 170 connected to the first seal structure 150 and enables the engagement of the seal 146 with the pillar garnish 144, and a seal portion 172 arranged covering and sealing the space between the A-pillar 118 and the fender 130. As shown, the hook portion 170 includes a mirrored J shape having a straight portion 174 and a bent portion 176 attached to a first end 178 of the straight portion 174 and arranged facing the straight portion 174 and defining a gap 180 therebetween. As shown, a lower portion of the pillar garnish 144 extends inside the gap 180 in the assembly of the seal 146 with the pillar garnish 144. Moreover, a free end 182 of the bent portion 176 is arranged abutting and attached to the step 168. The seal portion 172 extends from a second end 184 of the straight portion 174 and may be arranged at an inclination relative to the straight portion 174. As shown, the seal portion 172 extends in a direction away from the first seal structure 150.

Further to facilitate the secure engagement of the seal 146 with the pillar garnish 144, referring to FIG. 5, the pillar garnish 144 includes at least one engagement structure 190 engaged with at least one retention structure 192 of the first seal structure 150. In the illustrated embodiment, the at least one engagement structure 190 includes at least one pin 194 and at least one retention structure 192 includes at least one hole 196 extending through the first elongated portion 160 of the first seal structure 150. In the assembly of the seal 146 with the pillar garnish 144, the at least one pin 194 extends inside the at least one hole 196 of the first seal structure 150. Although the engagement structure 190 and the retention structure 192 are shown and contemplated as the pin 194 and the hole 196, respectively, it may be envisioned that the engagement structure 190 may be a hole and the retention structure 192 may be a pin.

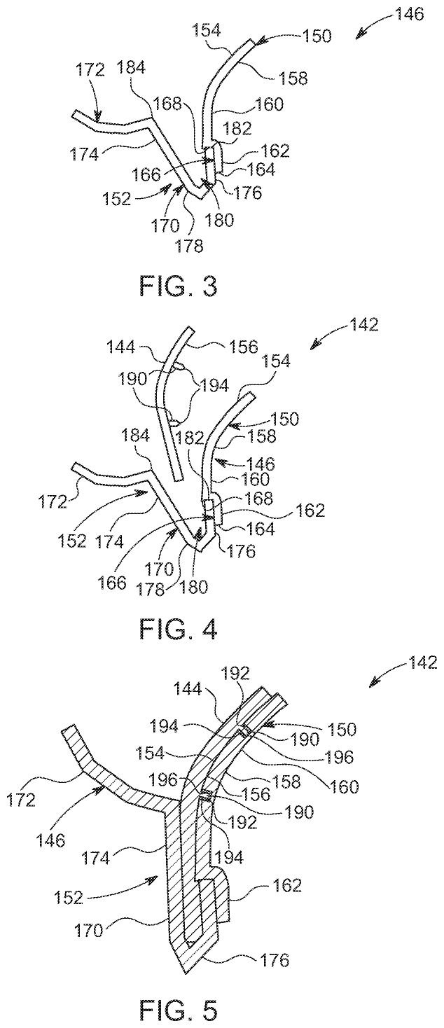

A method for forming/assembling the pillar garnish assembly 142 is now described. The method includes increasing the gap 180 of the hook portion 170. In an embodiment, a technician may increase the gap 180 by pulling the straight portion 174 away from the bent portion 176, as shown in FIG. 3. In some embodiments, a machine may be used to pull the straight portion 174 relative to the bent portion 176. Subsequently, as shown in FIG. 4, the technician may insert/position the lower portion of the pillar garnish 144 inside the increased gap 180, and then displaces the straight portion 174 along with the seal portion 172 towards the first seal structure 150. In this manner, as shown in FIGS. 2 and 5, the lower portion of the pillar garnish 144 is sandwiched between the straight portion 174 and the bent portion 176 of the hook portion 170, while an upper portion of the pillar garnish 144 is sandwiched/arranged between the first seal structure 150 i.e., first elongated portion 160 and the straight portion 174 of the second seal structure 152. Moreover, during displacement of the straight portion 174 towards the first seal structure 150 to close the gap 180, the technician may also rotate the pillar garnish 144 to align the pillar garnish 144 with the front surface 154 of the first seal structure 150 and suitably aligns the pins 194 of the pillar garnish 144 with the holes 196 of the seal 146. Further, the technician closes the gap 180 such that pins 194 are inserted inside the holes 196, thereby securing the pillar garnish 144 with the seal 146. In some embodiments, the technician may also weld the pillar garnish 144 with the first seal structure 150 i.e., the first elongated portion 160, as shown in FIG. 5. Thereafter, the technician may engage the pillar garnish assembly 142 with the vehicle body 108 such that pillar garnish 144 is supported on the A-pillar 118 with the first elongated portion 160 of the first seal structure 150 arranged between the A-pillar 118 and the pillar garnish 144, and the seal portion 172 arranged covering the space 140, contacting the associated fender 130.

The foregoing description of embodiments and examples has been presented for purposes of illustration and description. It is not intended to be exhaustive or to limit the invention to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the invention is, of course, not limited to the examples or embodiments set forth herein, but can be employed in any number of applications and equivalent devices by those of ordinary skill in the art. Rather it is hereby intended the scope of the invention be defined by the claims appended hereto.

What is claimed is:

1. A pillar garnish assembly for a vehicle, the pillar garnish assembly comprising:
a pillar garnish adapted to be provided on a front surface of a pillar of the vehicle; and
a seal adapted to engage with the pillar garnish and including
a first seal structure adapted to be arranged between the pillar garnish and the pillar and configured to be engaged with the pillar garnish, and
a second seal structure having
a hook portion engaged with the first seal structure and defining a gap to receive a portion of the pillar garnish, and
a seal portion extending at an angle to the hook portion and away from the hook portion, the seal portion is adapted to seal a space defined between the pillar and a fender of the vehicle.

2. The pillar garnish assembly of claim 1, wherein the first seal structure includes
a first elongated portion adapted to be arranged contacting a rear surface of the pillar garnish, and
a second elongated portion arranged at an offset of the first elongated portion defining a step therebetween,
wherein the second elongated portion is disposed at a distance from the rear surface of the pillar garnish in an assembly of the pillar garnish and the seal.

3. The pillar garnish assembly of claim 2, wherein the hook portion includes
a straight body arranged facing the first seal structure, and
a bent body extending from the straight body defining the gap therebetween, the bent body includes a free end engaged to the step of the first seal structure,
wherein the bent body is adapted to be arranged between the second elongated portion and the pillar garnish.

4. The pillar garnish assembly of claim 3, wherein the seal portion is engaged to the straight body and extends in a direction opposite to the bent body.

5. The pillar garnish assembly of claim 1, wherein
the pillar garnish includes at least one engagement structure, and
the first seal structure includes at least one retention structure adapted to engage with the at least one engagement structure to facilitate the engagement of the pillar garnish with the first seal structure.

6. The pillar garnish of claim 5, wherein the at least one engagement structure includes at least one pin and the at least one retention structure includes at least one hole to receive the at least one pin.

7. The pillar garnish of claim 1, wherein the first seal structure is made of a soft material relative to the second seal structure.

8. A vehicle, comprising:
a pillar;
a fender extending forwardly and downwardly of the pillar and defining a space therebetween;
a pillar garnish provided on a front surface of the pillar; and
a seal engaged with the pillar garnish and including
a first seal structure arranged between the pillar garnish and the pillar and engaged with the pillar garnish,
a second seal structure having
a hook portion engaged with the first seal structure and defining a gap, wherein a portion of the pillar garnish extends inside the gap, and
a seal portion extending at an angle to the hook portion and away from the hook portion, the seal portion is arranged covering the space defined between the pillar and the fender.

9. The vehicle of claim 8, wherein the first seal structure includes
a first elongated portion arranged contacting a rear surface of the pillar garnish, and
a second elongated portion extending from the first elongated portion and arranged at an offset from the rear surface of the pillar garnish defining a cavity therebetween.

10. The vehicle of claim 9, wherein the first seal structure includes a step defined at an interface of the first elongated portion and the second elongated portion.

11. The vehicle of claim 10, wherein the hook portion includes
a straight body arranged facing the first seal structure, and contacting a front surface of the pillar garnish, and
a bent body extending from the straight body defining the gap therebetween, wherein the bent body is arranged inside the cavity and includes a free end engaged to the step.

12. The vehicle of claim 11, wherein the seal portion is engaged to the straight body and extends in a direction opposite to the bent body and contacts the fender.

13. The vehicle of claim 8, wherein
the pillar garnish includes at least one engagement structure, and
the first seal structure includes at least one retention structure adapted to engage with the at least one engagement structure to facilitate the engagement of the pillar garnish with the first seal structure.

14. The vehicle of claim 13, wherein the at least one engagement structure includes at least one pin and the at least one retention structure includes at least one hole to receive the at least one pin.

15. The vehicle of claim 8, wherein the first seal structure is made of a soft material relative to the second seal structure.

16. A method for forming a pillar garnish assembly for a vehicle, the method comprising:
providing a pillar garnish;
providing a seal, wherein the seal includes
a first seal structure adapted to be arranged between the pillar garnish and a pillar of the vehicle and configured to be engaged with the pillar garnish, and
a second seal structure having
a hook portion engaged with the first seal structure and defining a gap to receive a portion of the pillar garnish, and
a seal portion extending at an angle to the hook portion and away from the hook portion, the seal portion is adapted to seal a space defined between the pillar and a fender of the vehicle;
increasing the gap of the hook portion;
inserting a lower portion of the pillar garnish inside the gap; and
displacing the pillar garnish and the seal portion towards the first seal structure to reduce the gap such that the lower portion of the pillar garnish is arranged inside the gap and an upper portion of the pillar garnish is sandwiched between the first seal structure and the second seal structure.

17. The method of claim 16 further including engaging the pillar garnish to the first seal structure by engaging at least one engagement structure of the pillar garnish with at least one retention structure of the first seal structure.

18. The method of claim 17, wherein engaging the pillar garnish to the first seal structure includes welding the pillar garnish with the first seal structure.

19. The method of claim 16, wherein the hook portion includes
a straight body connected to the seal portion and arranged facing the first seal structure, and
a bent body extending from the straight body defining the gap therebetween, wherein the bent body includes a free end engaged to a step of the first seal structure,
wherein the gap of the hook portion is increased by pulling the straight body away from the first seal structure.

20. The method of claim 16, wherein displacing the pillar garnish and the seal portion towards the first seal structure includes rotating the pillar garnish to align the pillar garnish with a front surface of the first seal structure.
